(19) United States
(12) Patent Application Publication
(10) Pub. No.: US 2011/0157878 A1
(43) Pub. Date: Jun. 30, 2011

(54) PHOTOVOLTAIC POWERED LIGHTING DEVICE

(75) Inventors: Wing-Yan LAI, Hong Kong (HK); Szu-Han Li, Taoyuan County (TW); Wei-Lun Hsiao, Taoyuan County (TW)

(73) Assignee: Du Pont Apollo Limited, Hong Kong (HK)

(21) Appl. No.: 12/958,421

(22) Filed: Dec. 2, 2010

Related U.S. Application Data
(60) Provisional application No. 61/290,598, filed on Dec. 29, 2009.

(51) Int. Cl. F21L 4/00

(52) U.S. Cl. 362/183

(57) ABSTRACT

A photovoltaic powered lighting device includes a protective frame, a photovoltaic module, and an LED lighting module. The photovoltaic module is fixed in the protective frame for transferring incident lights into electricity power. The LED lighting module is detachably disposed in the protective frame, so that the LED lighting module can be removed for replacement. Also, the LED lighting module electrically connects with the photovoltaic module.

### RELATED APPLICATIONS

This application claims priority to U.S. Provisional Application Ser. No. 61/290,598, filed Dec. 29, 2009, which is herein incorporated by reference.

### BACKGROUND

1. Technical Field

The invention relates to a lighting device, more particularly to a photovoltaic powered lighting device.

2. Description of Related Art

A conventional photovoltaic powered lighting device includes a solar cell module, an LED lighting module, two tempered glasses, and three intermediate layers (e.g. glass materials). In details, the two tempered glasses respectively cover two opposite sides of the photovoltaic powered lighting device. One of the intermediate layers is arranged between one of the tempered glasses and the solar cell module. Another one of the intermediate layers is arranged between the solar cell module and the LED lighting module. The other one of the intermediate layers is arranged between the other one of the tempered glasses and the LED lighting module.

One of manufacturing methods for the conventional photovoltaic powered lighting device is substantially divided into the steps of stacking the solar cell module and the LED lighting module together with the tempered glasses and the intermediate layers as the arrangement mentioned above, and completely integrating them together into a single combination set with a lamination process.

However, in order to make the single combination set mentioned above, vendors need to extra prepare several kinds of components such as the tempered glasses and the intermediate layers for protecting and isolating the solar cell module and the LED lighting module, and manufacturing machines regarding the press process for integrating them together. Thus, material costs and manufacturing costs for making the conventional photovoltaic powered lighting device could be substantially increased.

Furthermore, since the solar cell module is completely integrated into the single combination set with the lamination process, light transmissivity of the solar cell module is therefore degraded so as to decrease the light that the solar cell module receives. Also, since the LED lighting module is completely integrated into the single combination set with the press process, the LED lighting module could malfunction due to poor heat dissipation, and then the single combination set needs to be abandoned rather than to remove the LED lighting module only for replacement.

### SUMMARY

One objective of the present invention is to provide a photovoltaic powered lighting device which is able to simplify the structure of the conventional single combination set and the manufacturing method.

Another objective of the present invention is to provide a photovoltaic powered lighting device which is able to improve the light transmissivity of the photovoltaic powered lighting device.

The other objective of the present invention is to provide a photovoltaic powered lighting device which is able to remove the LED lighting module only when malfunctioned.

To achieve these and other advantages and in accordance with the objective of the present invention, as the embodiment broadly describes herein, the present invention provides a photovoltaic powered lighting device including at least one protective frame, one photovoltaic module and one LED lighting module. The photovoltaic module is fixed in the protective frame and provided for transferring incident lights into electricity power. The LED lighting module is detachably disposed in the protective frame, so that the LED lighting module can be removed away from the protective frame or installed into the protective frame. Also, the LED lighting module electrically connects with the photovoltaic module and emitting light by the generated electricity power.

In addition, the protective frame includes a main body, a first holding slot and a second holding slot. The first containing is arranged in the main body for holding the photovoltaic module. The second holding slot is arranged in the main body for holding the LED lighting module.

In one optional embodiment, the LED lighting module is flexible to insert into or remove away from the second holding slot.

In another optional embodiment, the protective frame further has a frame cover. The frame cover is movably disposed on the main body and neighboring the second holding slot.

In details of this embodiment, the frame cover includes a first part of the frame cover coupling with the main body, and a second part of the frame cover for covering or uncovering the second holding slot.

For one example, the first part of the frame cover is slidably disposed on the main body, so that the second part of the frame cover can be slid to cover or uncover the second holding slot.

For another example, the first part of the frame cover is pivotably disposed on the main body, so that the second part of the frame cover can be rotated to cover or uncover the second holding slot.

In details of this embodiment, the frame cover is detachably disposed on the main body, so that the frame cover can be totally removed to uncover the second holding slot or fixed in the main body to cover the second holding slot.

In another optional embodiment, the protective frame further has an electrically conductive path. The electrically conductive path is embedded in the main body, and electrically connects with both the photovoltaic module and the LED lighting module.

In addition, the present invention optionally provides an energy storage device. The energy storage device electrically connects with both the photovoltaic module and the LED lighting module.

In addition, the present invention optionally provides a controlling panel. The controlling panel electrically connects with the LED lighting module for controlling the LED lighting module. The controlling panel includes a controlling circuit and at least one light intensity sensor. The controlling circuit electrically connects with the LED lighting module. The light intensity sensor electrically connects with the controlling circuit for detecting a brightness change of the incident lights.

In another optional embodiment, the photovoltaic module includes a top glass substrate, a photovoltaic layer, an encapsulant layer and a bottom substrate. The photovoltaic layer is sandwiched between the top glass substrate and the bottom substrate. The encapsulant layer is disposed between the top glass substrate and the bottom substrate, and envelops the photovoltaic layer. In addition, the photovoltaic module further has a junction box provided on an edge of the photovoltaic layer, and electrically connects with both the photovoltaic layer and the LED lighting module.

In another optional embodiment, the LED lighting module has a substrate, a transparent light guide and a plurality of LED elements. These LED elements are mounted on the substrate. The transparent light guide is stackably disposed on the substrate and covers the LED elements to conduct the heat generated away from the LED elements.

In another optional embodiment, the protective frame further has a gap therein. The gap exists between the photovoltaic module and the LED lighting module. Therefore, heat generated from the photovoltaic module will be isolated from transferring to the LED lighting module.

In another optional embodiment, the photovoltaic powered lighting device is a photovoltaic roof device or a photovoltaic street lamp, and has an incident-light receiving surface and an LED light emitting surface thereof in which the incident-light receiving surface and the LED light emitting surface are opposite.

Accordingly, the photovoltaic powered lighting device according to the present invention can effectively simplify the structure of the conventional single combination set and the manufacturing method, so as to further decrease the material costs and the manufacturing costs. In addition, the photovoltaic powered lighting device according to the present invention effectively improves the light transmissivity of the photovoltaic powered lighting device so as to further amplify the capability of the photovoltaic powered lighting device.

Furthermore, the photovoltaic powered lighting device according to the present invention provides users to partly remove the LED lighting module rather than abandon the entire single combination set when the LED lighting module is malfunctioned.

### BRIEF DESCRIPTION OF THE DRAWINGS

FIG. 1 illustrates a photovoltaic powered lighting device according to one embodiment of the present invention.

FIG. 2A illustrates a photovoltaic powered lighting device according to another embodiment of the present invention.

FIG. 2B illustrates a photovoltaic powered lighting device according to another embodiment of the present invention.

FIG. 2C illustrates a photovoltaic powered lighting device according to another embodiment of the present invention.

FIG. 3 illustrates a photovoltaic powered lighting device with an electrically conductive path according to another one embodiment of the present invention.

FIG. 4 illustrates a block diagram of a photovoltaic powered lighting device according to another one embodiment of the present invention.

FIG. 5 illustrates a block diagram of a photovoltaic powered lighting device with a controlling panel according to another one embodiment of the present invention.

FIG. 6 illustrates a photovoltaic module of a photovoltaic powered lighting device according to another one embodiment of the present invention.

FIG. 7 illustrates an LED lighting module of a photovoltaic powered lighting device according to another one embodiment of the present invention.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

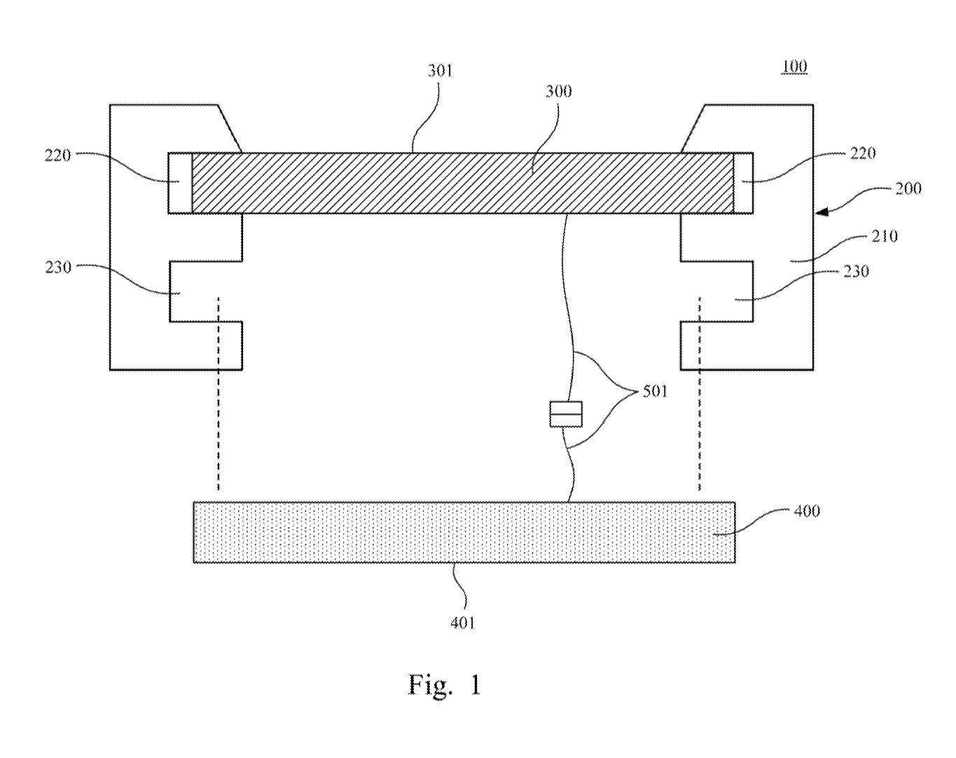

Refer to FIG. 1. FIG. 1 illustrates a photovoltaic powered lighting device according to one embodiment of the present invention. The photovoltaic powered lighting device 100 includes one protective frame 200, at least one photovoltaic module 300 and at least one LED lighting module 400. The photovoltaic module 300 is fixed in the protective frame 200. The photovoltaic module 300 is with an incident-light receiving surface 301 for receiving incident light from outside, and the photovoltaic module 300 transfers the received incident light into electricity power. The LED lighting module 400 is detachably disposed in the protective frame 200 opposite to the incident-light receiving surface 301 of the photovoltaic module 300. The LED lighting module 400 has a light-emitting surface 401 for emitting LED light. The LED lighting module 400 electrically connects with the photovoltaic module 300 via connections 501 when the LED lighting module 400 is installed in the protective frame 200.

Thus, the LED lighting module 400 can be removed away from the protective frame 200 or installed into the protective frame 200 for replacement rather than abandon the entire device when the LED lighting module 400 is malfunctioned.

Refer to FIG. 1 again. In details, the protective frame 200 includes a main body 210, one or more first holding slots 220 and second holding slots 230. The first holding slots 220 are defined in an inner side of the main body 210. The second holding slots 230 are defined in the inner side of the main body 210 adjacent to the first holding slots 220. The photovoltaic module 300 inserts into the first holding slots 220 for being held. The LED lighting module 400 inserts into the second holding slots 230 for being held.

Some varied optional embodiments in regard to the LED lighting module 400 detachably disposed on the protective frame 200 are provided as follows.

Refer to FIG. 1 again. In one optional embodiment, the LED lighting module 400 can be made of flexible materials, so that the LED lighting module 400 is able to be bended for inserting into or removing away from the second holding slot 230. Thus, when the LED lighting module 400 is bended to install into the second holding slots 230, the LED lighting module 400 is blocked and held on the main body 210.

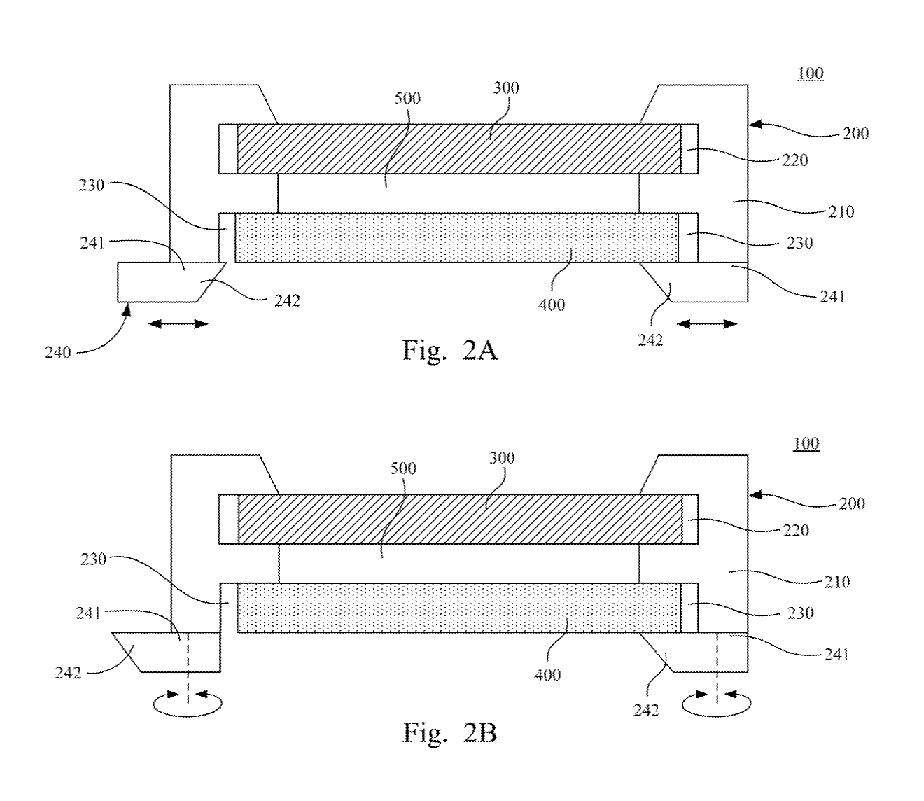

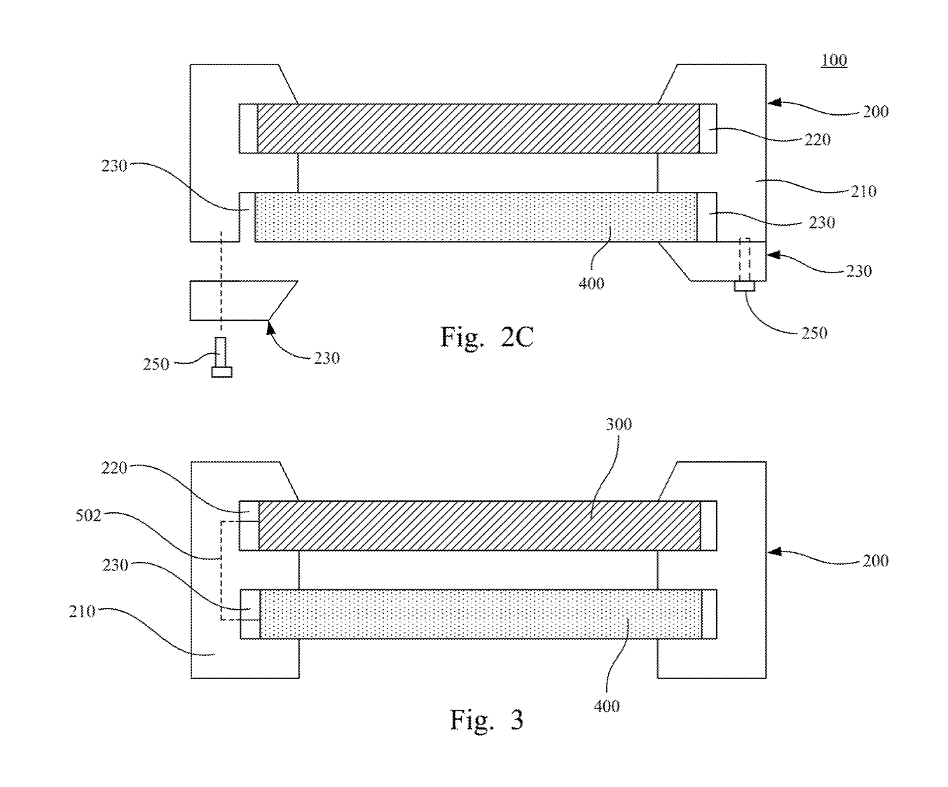

Refer to FIG. 2A and FIG. 2B, in which FIG. 2A and FIG. 2B illustrate a photovoltaic powered lighting device according to two different embodiments of the present invention. In another optional embodiment, the protective frame 200 further has at least one frame cover 240. Generally, the frame cover 240 is movably disposed on the main body 210 and neighbors the second holding slot 230.

For one example, the frame cover 240 has a first part 241 and a second part 242 physically which are connected mutually. The first part 241 of the frame cover 240 movably couples with the main body 210. The second part 242 of the frame cover 240 can be moved (e.g. sliding or rotating etc.) for covering or uncovering the second holding slot 230.

In one of the variations of the frame cover 240 (FIG. 2A), the first part 241 is slidably disposed on the main body 210 and neighbors the second holding slot 230, thus, the second part 242 of the frame cover 240 can be slid to cover or uncover one of the second holding slots 230. Therefore, when the frame cover 240 is slid to move away from one of the second holding slots 230, the LED lighting module 400 is free to be removed; otherwise, when the frame cover 240 is slid to cover one of the second holding slots 230, the frame cover 240 locks the LED lighting module 400, and the LED lighting module 400 is held in the protective frame 200.

In another one of the variations of the frame cover 240 (FIG. 2B), the first part 241 is pivotably disposed on the main body 210, so that the second part 242 of the frame cover 240 can be rotated to cover or uncover one of the second holding slots 230. Therefore, when the frame cover 240 is rotated to move away from one of the second holding slots 230, the LED lighting module 400 is free to be removed; otherwise, when the frame cover 240 is rotated to cover one of the second holding slots 230, the frame cover 240 locks the LED lighting module 400, and the LED lighting module 400 is held in the protective frame 200.

Refer to FIG. 2C. FIG. 2C illustrates a photovoltaic powered lighting device according to another embodiment of the present invention. For another example, the frame cover 240 is detachably disposed on the main body 210, so that the frame cover 240 can be fixed on the main body 210 to cover the second holding slot 230.

Thus, when the frame cover 240 is fixed on the main body 210 to cover the second holding slot 230 by a fixing member 250 (e.g. screw or pin etc.), the LED lighting module 400 in the second holding slot 230 can be held in the protective frame 200; otherwise, when the fixing member 250 and the frame cover 240 are removed away from the second holding slot 230, the LED lighting module 400 is free to be removed.

Refer to FIG. 3. FIG. 3 illustrates a photovoltaic powered lighting device with an electrically conductive path according to another one embodiment of the present invention. In addition, the protective frame 200 further provides an electrically conductive path 502 thereon in another optional embodiment of the present invention. The electrically conductive path 502 (e.g. conductive cable or trace) is embedded in the main body 210 or provided on an inner surface of main body 210. One end of the electrically conductive path 502 electrically connects with the photovoltaic module 300 on the inner surface thereof in the first holding slot 220. The other end of the electrically conductive path 502 electrically connects with the LED lighting module 400 on the inner surface thereof in the second holding slot 230. Besides, the protective frame 200 can be made of metal, plastic or a combination of metal and plastic.

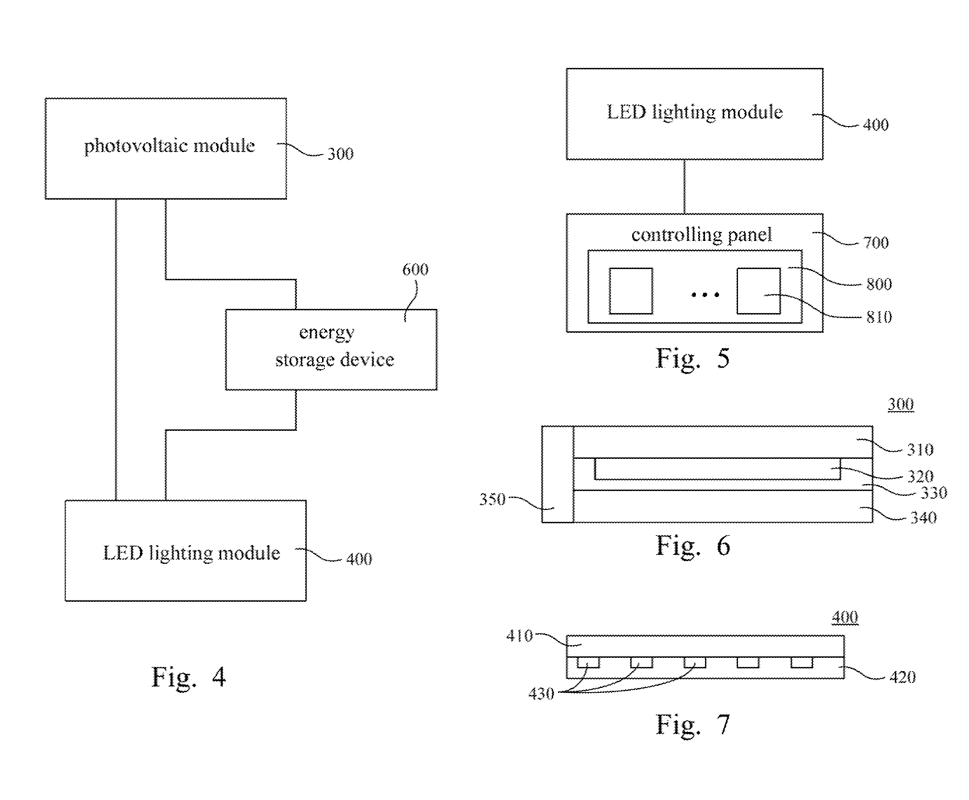

Refer to FIG. 4. FIG. 4 illustrates a block diagram of a photovoltaic powered lighting device according to another one embodiment of the present invention. Furthermore, the present invention optionally provides an energy storage device 600 in another optional embodiment. The energy storage device 600 such as a charge battery or a capacitor, electrically connects with both the photovoltaic module 300 and the LED lighting module 400. The electricity power generated by the photovoltaic module 300 can be saved in the energy storage device 600 for the LED lighting module 400 in the night or other purpose, besides directly providing for the LED lighting module 400.

Refer to FIG. 5. FIG. 5 illustrates a block diagram of a photovoltaic powered lighting device with a controlling panel according to another one embodiment of the present invention. In addition to energy storage device 600 (FIG. 4), the present invention optionally provides a controlling panel 700 in another optional embodiment. The controlling panel 700 electrically connects with the LED lighting module 400 for controlling the LED lighting module 400. The controlling panel 700 includes a controlling circuit 800 and at least one light intensity sensor 810. The controlling circuit 800 electrically connects with the LED lighting module 400. The light intensity sensor 810 electrically connects with the controlling circuit 800 for detecting a brightness change of the incident lights.

Thus, when the brightness of the incident lights is less than a predetermined standard (e.g. an averaged brightness in dusk), the controlling circuit 800 switches the LED lighting module 400 on, thus, the LED lighting module 400 will emit lights from the light-emitting surface 401; Visa versa.

It needs to be noted that the controlling panel 700 is not limited to be provided internally or externally on the protective frame 200.

Refer to FIG. 6. FIG. 6 illustrates a photovoltaic module of a photovoltaic powered lighting device according to another one embodiment of the present invention. In another optional embodiment, the photovoltaic module 300 includes a top glass substrate 310 (e.g. but not limit to a tempered glass substrate), a photovoltaic layer 320 (e.g. photovoltaic thin film), an encapsulant layer 330 (e.g. photovoltaic encapsulant) and a bottom substrate 340 (e.g. but not limit to a glass substrate or a backsheet). The photovoltaic layer 320 and the encapsulant layer 330 are sandwiched between the top glass substrate 310 and the bottom layer 340, and the encapsulant layer 330 envelops the photovoltaic layer 320. Alternatively, the photovoltaic module 300 can further has a junction box 350 provided on an edge of the photovoltaic module 300, and electrically connects with both the photovoltaic layer 320 and the LED lighting module 400 according to the demands.

Refer to FIG. 7. FIG. 7 illustrates an LED lighting module of a photovoltaic powered lighting device according to another one embodiment of the present invention. In another optional embodiment, the LED lighting module 400 has a substrate 410 (e.g. glass substrate), a transparent light guide 420 and a plurality of LED elements 430. These LED elements 430 are mounted on the substrate 410. The transparent light guide 420 is stacked on the substrate 410 and covers the LED elements. In addition, the transparent light guide 420 is made of plastic materials such as Thermoplastic Polyurethane (TPU), such that the heat generated from the LED elements can be conducted away from the LED elements 430. Also, the LED lighting module 400 can be presented as an LED array or a plurality of LED light bars.

Furthermore, the protective frame 200 further provides a spaced gap 500 therein in another optional embodiment of the present invention shown in FIG. 2A. The spaced gap 500 exists between the photovoltaic module 300 and the LED lighting module 400, which indicates that the photovoltaic module 300 and the LED lighting module 400 are not physically contacted.

Therefore, heat generated from the photovoltaic module 300 will be isolated and stopped from transferring to the LED lighting module 400. Also, since the photovoltaic module 300 does not physically contact the LED lighting module 400, heat generated from the LED lighting module 400 can be bi-directionally dissipated. Thus, the LED lighting module 400 could live longer due to better heat dissipation.

Refer to FIG. 1 again. In practice, the photovoltaic powered lighting device 100 in another optional embodiment can be applied as a photovoltaic roof device on a roof, or a photovoltaic street lamp on a road. Meanwhile, the incident-light receiving surface 301 and the light-emitting surface 401 are opposite.

To sum up, the photovoltaic powered lighting device of the present invention effectively decreases the material costs and the manufacturing costs, amplifies the capability of the photovoltaic powered lighting device, and provides users to partly remove the LED lighting module rather than abandon the entire device when the LED lighting module is malfunctioned.

The readers attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A photovoltaic powered lighting device, comprising:
a protective frame;
a photovoltaic module fixed in the protective frame for transferring incident lights into electricity power; and
an LED lighting module detachably disposed in the protective frame, and electrically connected with the photovoltaic module.

2. The photovoltaic powered lighting device according to claim 1, wherein the protective frame comprises:
a main body;
a first holding slot arranged on the main body for holding the photovoltaic module; and
a second holding slot arranged on the main body for holding the LED lighting module.

3. The photovoltaic powered lighting device according to claim 2, wherein the LED lighting module is flexible to insert into or remove away from the second holding slot.

4. The photovoltaic powered lighting device according to claim 2, wherein the protective frame further comprises:
a frame cover movably disposed on the main body and neighboring the second holding slot.

5. The photovoltaic powered lighting device according to claim 4, wherein the frame cover comprises:
a first part of the frame cover coupling with the main body; and
a second part of the frame cover for covering or uncovering the second holding slot.

6. The photovoltaic powered lighting device according to claim 5, wherein the first part of the frame cover is slidably disposed on the main body, so that the second part of the frame cover is capable of being slid to cover the second holding slot.

7. The photovoltaic powered lighting device according to claim 5, wherein the first part of the frame cover is pivotably disposed on the main body, so that the second part of the frame cover is capable of being rotated to cover the second holding slot.

8. The photovoltaic powered lighting device according to claim 4, wherein the frame cover is detachably disposed on the main body, so that the frame cover is capable of being fixed on the main body to cover the second holding slot.

9. The photovoltaic powered lighting device according to claim 2, wherein the protective frame further comprises:
an electrically conductive path embedded in the main body, and electrically connected with both the photovoltaic module and the LED lighting module.

10. The photovoltaic powered lighting device according to claim 1, further comprising:
an energy storage device electrically connected with both the photovoltaic module and the LED lighting module.

11. The photovoltaic powered lighting device according to claim 1, further comprising a controlling panel electrically connected with the LED lighting module for controlling the LED lighting module, the controlling panel comprises:
a controlling circuit electrically connected with the LED lighting module; and
at least one light intensity sensor electrically connected with the controlling circuit for detecting a brightness change of the incident lights.

12. The photovoltaic powered lighting device according to claim 10, wherein the controlling panel is provided internally or externally on the protective frame.

13. The photovoltaic powered lighting device according to claim 1, wherein the protective frame further has a spaced gap therein arranged between the photovoltaic module and the LED lighting module.

14. The photovoltaic powered lighting device according to claim 1, wherein the photovoltaic module comprises:
a top glass substrate and a bottom substrate;
a photovoltaic layer sandwiched between the top glass substrate and the bottom substrate; and
an encapsulant layer disposed between the top glass substrate and the bottom substrate, and enveloping the photovoltaic layer.

15. The photovoltaic powered lighting device according to claim 14, wherein the photovoltaic module further comprises:
a junction box provided on an edge of the photovoltaic module, and electrically connected with the photovoltaic layer and the LED lighting module.

16. The photovoltaic powered lighting device according to claim 1, wherein the LED lighting module comprises:
a substrate;
a plurality of LED elements mounted on the substrate; and
a transparent light guide stackably disposed on the substrate and covering the LED elements.

17. The photovoltaic powered lighting device according to claim 16, wherein the transparent light guide is made of Thermoplastic Polyurethane (TPU).

18. The photovoltaic powered lighting device according to claim 1, wherein the LED lighting module is with an LED array or a plurality of LED light bars.

19. The photovoltaic powered lighting device according to claim 1, wherein the

20. The photovoltaic powered lighting device according to claim 1, wherein the photovoltaic powered lighting device is a photovoltaic roof device or a photovoltaic street lamp.
